(19) United States
(12) Patent Application Publication
(10) Pub. No.: US 2026/0189992 A1
(43) Pub. Date: Jul. 2, 2026

(54) Methods and Apparatus for Enhanced Physical Layer Measurement Reporting in Wireless Communications

(71) Applicant: Apple Inc., Cupertino, CA (US)

(72) Inventors: Hong He, San Jose, CA (US); Chunhai Yao, Beijing (CN); Chunxuan Ye, San Diego, CA (US); Huaning Niu, San Jose, CA (US); Seyed Ali Akbar Fakoorian, San Diego, CA (US); Oghenekome Oteri, San Diego, CA (US); Wei Zeng, Saratoga, CA (US); Dawei Zhang, Saratoga, CA (US); Haitong Sun, Saratoga, CA (US); Jie Cui, San Jose, CA (US)

(21) Appl. No.: 19/114,139

(22) PCT Filed: Nov. 3, 2022
(86) PCT No.: PCT/CN2022/129477

§ 371 Date: Mar. 21, 2025

(51) Int. Cl. H04W 36/00; H04B 7/06; H04W 24/08; H04W 24/10; H04W 72/21

(52) U.S. Cl. CPC H04W 36/0058; H04B 7/0626; H04W 24/08; H04W 24/10; H04W 72/21

(57) ABSTRACT

Enhanced physical layer (PL) Channel State Information (CSI) measurement and reporting may include cell-level PL CSI measurement (PCSM) reporting to the network by mobile devices (UEs). Cell-level PCSM results may be derived for an FR2 frequency layer by averaging PCSM results corresponding to a specified number of best Synchronization Signal/Physical Broadcast Channel Block (SSB) beams. The UE may optionally report cell-level or beam-level PCSM results. The maximum number of averaged beams and beam consolidation thresholds may be set by parameters in the PL CSI measurement configuration. The report may be transmitted in a MAC-CE, or as uplink control information (UCI) by configuring (e.g., via RRC) the PUCCH or PUSCH resource as part of the PL CSI measurement configuration. A measurement gap may also be configured as part of the PL CSI measurement configuration for support measurements on target cells on a different frequency relative to the serving cell.

### FIELD OF THE INVENTION

The present application relates to wireless communications, including enhanced physical layer measurement and reporting during wireless communications, e.g., during 5G NR communications.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (WCDMA, TDS-CDMA), LTE, LTE Advanced (LTE-A), HSPA, 3GPP2 CDMA2000 (e.g., 1×RTT, 1×EV-DO, HRPD, eHRPD), IEEE 802.11 (WLAN or Wi-Fi), IEEE 802.16 (WiMAX), BLUETOOTH™, etc. A current telecommunications standard moving beyond previous standards is called 5th generation mobile networks or 5th generation wireless systems, referred to as 3GPP NR (otherwise known as 5G-NR or NR-5G for 5G New Radio, also simply referred to as NR). NR proposes a higher capacity for a higher density of mobile broadband users, also supporting device-to-device, ultra-reliable, and massive machine communications, as well as lower latency and lower battery consumption, than LTE standards.

One aspect of wireless communication systems, including NR cellular wireless communications, is measurement and reporting of various channel and communication metrics. There has been an emergence of mobile services that require low-latency and high-reliability performance (e.g., ultra-reliable low-latency communication, URLLC). While the 5G standard has been designed to address these services, the evolution of 5G New Radio (NR) requires continued enhancement of mobility performance robustness for a variety of challenging scenarios.

### SUMMARY OF THE INVENTION

Embodiments are presented herein of, inter alia, of methods and procedures for enhanced physical layer measurement reporting during wireless communications, for example during 3GPP New Radio (NR) communications. Embodiments are further presented herein for wireless communication systems containing at least wireless communication devices or user equipment devices (UEs) and/or base stations communicating with each other within the wireless communication systems.

In some embodiments, enhanced physical layer (L1) measurement and reporting may include cell-level measurement metric (MM) reporting to the network by mobile devices (UEs). Cell-level L1 MM results may be derived for an FR2 frequency layer by averaging measured L1 MMs corresponding to a specified number of best Synchronization Signal/Physical Broadcast Channel Block (SSB) beams. The UE may optionally select whether to report cell-level or beam-level measurements. The maximum number of beams to be averaged and beam consolidation thresholds may be set by corresponding parameters configured in the L1 measurement configuration. Event-triggered measurement reporting may also be implemented, for example in MAC-CE based reporting or by reporting the L1 measurement report as uplink control information (UCI) by configuring (e.g., via RRC) the PUCCH or PUSCH resource as part of the L1 measurement configuration. Finally, a measurement gap may also be configured as part of the L1 measurement configuration for support measurements on target cells on a different frequency relative to the serving cell.

Pursuant to the above, a device may obtain, via physical-layer (PL) Channel State Information (CSI) measurements, one or more PL CSI measurement results corresponding to one or more CSI resource sets transmitted from one or more beams associated with one or more candidate cells of one or more target base stations. The device may then transmit, to a serving base station, a PL CSI measurement report that contains information derived from the one or more PL CSI measurement results, with the PLCSI measurement report configured for use in a determination to switch the device, in a layer1/layer2 (L1/L2)-triggered mobility (LTM) operation, from the serving base station to a selected target base station of the one or more target base stations.

The device may obtain an averaged PL CSI measurement result by averaging PL CSI measurement results that correspond to multiple beams associated with a single target base station. The device may similarly obtain multiple averaged PL CSI measurement results by averaging multiple sets of PL CSI measurement results, with each different set of PL CSI measurement results corresponding to a respective number of beams associated with a different respective target base station. The information may then include the averaged PL CSI measurement result or the multiple averaged PL CSI measurement results. The multiple beams may include a specified number of best beams, with each best beam of the specified number of best beams associated with a synchronization signal/physical broadcast channel block (SSB). Similarly, each respective number of beams may include a number of respective best beams, with each best beam of the number of respective best beams associated with an SSB. The averaging may be linear averaging or averaging using coefficient values configured via radio resource control (RRC) signaling. The PL CSI measurement results used in the averaging may include only PL CSI measurement results having a greater value than a specified threshold value. In some embodiments, the specified threshold value, the number of beams, and/or the number of each respective group of beams (when obtaining multiple averaged PL CSI measurement results) may be configured in a PL CSI measurement configuration.

In some embodiments, the information may be derived from PL CSI measurement results that each correspond to a single respective beam. The decision to derive the information in such a manner may be based on the value of a parameter configured in a PL CSI measurement configuration.

Transmission of the PL CSI measurement report may be based on a trigger event, with the trigger determined based on a comparison of first information and second information. The first information may be derived from a first set of PL CSI measurement results corresponding to the serving base station, and the second information may be derived from a second set of PL CSI measurement results corresponding to a candidate target base station. The trigger event may be triggered when the comparison indicates that a result indicated by the second information is better than a result indicated by the first information by at least a configurable offset value.

The PL CSI measurement report may be transmitted in a media access control element (MAC-CE) of variable size. The MAC-CE may include a first information field that contains a best beam index identifying a best beam, a specified PL CSI measurement result for the best beam, and an associated cell index for the best beam. The MAC-CE may further include a second information field that contains beam indices identifying a specified number of reported beams, PL CSI measurement results for each reported beam of the specified number of reported beams, and associated cell indices for the specified number of reported beams. The specified PL CSI measurement result may represent a largest value among multiple PL CSI measurement results. For multiple reported beams, a differential PL CSI reporting may be used with reference to the specified PL CSI measurement result. Each PL CSI reporting for the number of reported beams may be quantized to a smaller number of bits by using a larger step size.

In some embodiments, the PL CSI measurement report may be transmitted as uplink control information (UCI) using either one of a physical uplink control channel (PUCCH) resource or a physical uplink shared channel (PUSCH) resource. Either one or both of the PUCCH resource or the PUSCH resource may be configured via radio resource control information as part of a PL CSI measurement configuration. The UCI may include a first information field that contains a best beam index identifying a best beam, a specified PL CSI measurement result for the best beam, and an associated cell index for the best beam. The UCI may further include a second information field that contains beam indices identifying a specified number of reported beams, PL CSI measurement results for each reported beam of the specified number of reported beams, and associated cell indices for the specified number of reported beams. The specified number (of the specified number of beams) may be variable and indicated by the first information field. Furthermore, a number of resource elements (REs) corresponding to the specified number (of the specified number of reported beams) provided in the first information field may be derived based on a parameter value configured via radio resource control.

In some embodiments, a measurement gap for the PL CSI measurements may be configured as part of a PL CSI measurement configuration, and with the measurement gap indicated per a non-serving cell of a target base station or per a frequency layer.

Note that the techniques described herein may be implemented in and/or used with a number of different types of devices, including but not limited to, base stations, access points, cellular phones, portable media players, tablet computers, wearable devices, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 shows an exemplary simplified block diagram illustrative of cellular communication circuitry, according to some embodiments;

FIG. 6 shows an exemplary diagram illustrating one example of cell-specific L1 measurement, according to some embodiments;

FIG. 7 shows an exemplary table comparison indicating the number of reported values included in L1 measurement reports for a given L1 measurement metric, according to some embodiments;

FIG. 8 shows an exemplary diagram illustrating beam reporting for L1 measurement reporting using a new MAC-CE element, according to some embodiments; and

FIG. 9 shows an exemplary diagram illustrating beam reporting for L1 measurement reporting using UCI by PUCCH or PUSCH, according to some embodiments;

FIG. 10 shows, shows exemplary code illustrating the inclusion of a measurement gap indication parameter on a per non-serving-cell basis, according to some embodiments;

FIG. 11 shows exemplary code illustrating the inclusion of a measurement gap indication parameter on a per frequency-layer-basis, according to some embodiments; and

FIG. 12 shows an exemplary flow diagram illustrating obtaining and transmitting a physical layer measurement report, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF THE EMBODIMENTS

### Acronyms

Various acronyms are used throughout the present application. Definitions of the most prominently used acronyms that may appear throughout the present application are provided below:
5GMM: 5G Mobility Management
AF: Application Function
AMF: Access and Mobility Management Function
AMR: Adaptive Multi-Rate
AP: Access Point
APN: Access Point Name
APR: Applications Processor
BS: Base Station
BSSID: Basic Service Set Identifier
CBG: Code Block Group
CBRS: Citizens Broadband Radio Service
CBSD: Citizens Broadband Radio Service Device
CCA: Clear Channel Assessment
CMR: Change Mode Request
CORESET: Control Resource Set
CS: Circuit Switched
CSI: Channel State Information
DCI: Downlink Control Information
DL: Downlink (from BS to UE)
DMRS: Demodulation Reference Signal
DN: Data Network
DSDS: Dual SIM Dual Standby
DYN: Dynamic
EDCF: Enhanced Distributed Coordination Function
eSNPN: Equivalent Standalone Non-Public Network
ETSI: European Telecommunications Standards Institute
FDD: Frequency Division Duplexing
FT: Frame Type
GAA: General Authorized Access
GPRS: General Packet Radio Service
GSM: Global System for Mobile Communication
GTP: GPRS Tunneling Protocol
HPLMN: Home Public Land Mobile Network
IC: In Coverage
ICBM: Inter-Cell Beam Management
IMS: Internet Protocol Multimedia Subsystem
IOT: Internet of Things
IP: Internet Protocol
ITS: Intelligent Transportation Systems
LAN: Local Area Network
LBT: Listen Before Talk
LCID: Logical Channel ID
LCS: Location Services
LMF: Location Management Function
LPP: LTE Positioning Protocol
LQM: Link Quality Metric
LTE: Long Term Evolution
MCC: Mobile Country Code
MCS: Modulation and Coding Scheme
MNO: Mobile Network Operator
MO-LR: Mobile Originated Location Request
MT-LR: Mobile-Terminated Location Request
NAS: Non-Access Stratum
NDI: New Data Indicator
NF: Network Function
NG-RAN: Next Generation Radio Access Network
NID: Network Identifier
NMF: Network Identifier Management Function
NPN: Non-Public (cellular) Network
NRF: Network Repository Function
NSI: Network Slice Instance
NSSAI: Network Slice Selection Assistance Information
OOC: Out Of Coverage
PAL: Priority Access Licensee
PBCH: Physical Broadcast Channel
PDCP: Packet Data Convergence Protocol
PDN: Packet Data Network
PDU: Protocol Data Unit
PGW: PDN Gateway
PLMN: Public Land Mobile Network
ProSe: Proximity Services
PRS: Positioning Reference Signal
PSCCH: Physical Sidelink Control Channel
PSFCH: Physical Sidelink Feedback Channel
PSSCH: Physical Sidelink Shared Channel
PSD: Power Spectral Density
PSS: Primary Synchronization Signal
PT: Payload Type
PTRS: Phase Tracking Reference Signal
PUCCH: Physical Uplink Control Channel
QBSS: Quality of Service Enhanced Basic Service Set
QI: Quality Indicator
RA: Registration Accept
RAT: Radio Access Technology
RF: Radio Frequency
RNTI: Radio Network Temporary Identifier
ROHC: Robust Header Compression
RR: Registration Request
RRC: Radio Resource Control
RS: Reference Signal
RSRP: Reference Signal Receive Power
RTP: Real-time Transport Protocol
RV: Redundancy Version
RX: Reception/Receive
SAS: Spectrum Allocation Server
SD: Slice Descriptor
SI: System Information
SIB: System Information Block
SID: System Identification Number
SIM: Subscriber Identity Module
SGW: Serving Gateway
SMF: Session Management Function
SNPN: Standalone Non-Public Network
SRS: Sounding Reference Signal
SSS: Secondary Synchronization Signal
SUPI: Subscription Permanent Identifier
TBS: Transport Block Size
TCP: Transmission Control Protocol
TDD: Time Division Duplexing
TDRA: Time Domain Resource Allocation
TPC: Transmit Power Control
TX: Transmission/Transmit
UAC: Unified Access Control
UDM: Unified Data Management
UDR: User Data Repository
UE: User Equipment
UI: User Input
UL: Uplink (from UE to BS)
UMTS: Universal Mobile Telecommunication System
UPF: User Plane Function
URLLC: Ultra-Reliable Low-Latency Communication
URM: Universal Resources Management
URSP: UE Route Selection Policy
USIM: User Subscriber Identity Module
Wi-Fi: Wireless Local Area Network (WLAN) RAT based on the Institute of Electrical and Electronics Engineers' (IEEE) 802.11 standards
WLAN: Wireless LAN
ZP: Zero Power

### Terms

The following is a glossary of terms that may appear in the present application:
Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.
Carrier Medium—a memory medium as described above, as well as a physical transmission medium, such as a bus, network, and/or other physical transmission medium that conveys signals such as electrical, electromagnetic, or digital signals.
Programmable Hardware Element—Includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.
Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.
User Equipment (UE) (or “UE Device”)—any of various types of computer systems devices which perform wireless communications. Also referred to as wireless communication devices, many of which may be mobile and/or portable. Examples of UE devices include mobile telephones or smart phones (e.g., iPhone™, Android™-based phones) and tablet computers such as iPad™, Samsung Galaxy™, etc., gaming devices (e.g. Sony PlayStation™, Microsoft XBox™, etc.), portable gaming devices (e.g., Nintendo DS™, PlayStation Portable™, Gameboy Advance™, iPod™), laptops, wearable devices (e.g. smart watch, smart glasses), PDAs, portable Internet devices, music players, data storage devices, or other handheld devices, unmanned aerial vehicles (e.g., drones) and unmanned aerial controllers, etc. Various other types of devices would fall into this category if they include Wi-Fi or both cellular and Wi-Fi communication capabilities and/or other wireless communication capabilities, for example over short-range radio access technologies (SRATs) such as BLUETOOTH™, etc. In general, the term “UE” or “UE device” may be broadly defined to encompass any electronic, computing, and/or telecommunications device (or combination of devices) which is capable of wireless communication and may also be portable/mobile.
Wireless Device (or wireless communication device)—any of various types of computer systems devices which performs wireless communications using WLAN communications, SRAT communications, Wi-Fi communications and the like. As used herein, the term “wireless device” may refer to a UE device, as defined above, or to a stationary device, such as a stationary wireless client or a wireless base station. For example a wireless device may be any type of wireless station of an 802.11 system, such as an access point (AP) or a client station (UE), or any type of wireless station of a cellular communication system communicating according to a cellular radio access technology (e.g. 5G NR, LTE, CDMA, GSM), such as a base station or a cellular telephone, for example.
Communication Device—any of various types of computer systems or devices that perform communications, where the communications can be wired or wireless./communication device can be portable (or mobile) or may be stationary or fixed at a certain location. A wireless device is an example of a communication device. A UE is another example of a communication device.
Base Station (BS)—The term “Base Station” has the full breadth of its ordinary meaning, and at least includes a wireless communication station installed at a fixed location and used to communicate as part of a wireless telephone system or radio system.
Processor—refers to various elements (e.g. circuits) or combinations of elements that are capable of performing a function in a device, e.g. in a user equipment device or in a cellular network device. Processors may include, for example: general purpose processors and associated memory, portions or circuits of individual processor cores, entire processor cores or processing circuit cores, processing circuit arrays or processor arrays, circuits such as ASICs (Application Specific Integrated Circuits), programmable hardware elements such as a field programmable gate array (FPGA), as well as any of various combinations of the above.
Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.
Band (or Frequency Band)—The term “band” has the full breadth of its ordinary meaning, and at least includes a section of spectrum (e.g., radio frequency spectrum) in which channels are used or set aside for the same purpose. Furthermore, “frequency band” is used to denote any interval in the frequency domain, delimited by a lower frequency and an upper frequency. The term may refer to a radio band or an interval of some other spectrum. A radio communications signal may occupy a range of frequencies over which (or where) the signal is carried. Such a frequency range is also referred to as the bandwidth of the signal. Thus, bandwidth refers to the difference between the upper frequency and lower frequency in a continuous band of frequencies. A frequency band may represent one communication channel or it may be subdivided into multiple communication channels. Allocation of radio frequency ranges to different uses is a major function of radio spectrum allocation. For example, in 5G NR, the operating frequency bands are categorized in two groups. More specifically, per 3GPP Release 15, frequency bands are designated for different frequency ranges (FR) and are defined as FR1 and FR2, with FR1 encompassing the 410 MHz-7125 MHz range and FR2 encompassing the 24250 MHz-52600 MHz range.
Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.
Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.
Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.
Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.
Station (STA)—The term “station” herein refers to any device that has the capability of communicating wirelessly, e.g. by using the 802.11 protocol. A station may be a laptop, a desktop PC, PDA, access point or Wi-Fi phone or any type of device similar to a UE. An STA may be fixed, mobile, portable or wearable. Generally in wireless networking terminology, a station (STA) broadly encompasses any device with wireless communication capabilities, and the terms station (STA), wireless client (UE) and node (BS) are therefore often used interchangeably.
Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.
Transmission Scheduling—Refers to the scheduling of transmissions, such as wireless transmissions. In some implementations of cellular radio communications, signal and data transmissions may be organized according to designated time units of specific duration during which transmissions take place. As used herein, the term “slot” has the full extent of its ordinary meaning, and at least refers to a smallest (or minimum) scheduling time unit in wireless communications. For example, in 3GPP LTE, transmissions are divided into radio frames, each radio frame being of equal (time) duration (e.g. 10 ms). A radio frame in 3GPP LTE may be further divided into a specified number of (e.g. ten) subframes, each subframe being of equal time duration, with the subframes designated as the smallest (minimum) scheduling unit, or the designated time unit for a transmission. Thus, in a 3GPP LTE example, a “subframe” may be considered an example of a “slot” as defined above. Similarly, a smallest (or minimum) scheduling time unit for 5G NR (or NR, for short) transmissions is referred to as a “slot”. In different communication protocols the smallest (or minimum) scheduling time unit may also be named differently.
Resources—The term “resource” has the full extent of its ordinary meaning and may refer to frequency resources and time resources used during wireless communications. As used herein, a resource element (RE) refers to a specific amount or quantity of a resource. For example, in the context of a time resource, a resource element may be a time period of specific length. In the context of a frequency resource, a resource element may be a specific frequency bandwidth, or a specific amount of frequency bandwidth, which may be centered on a specific frequency. As one specific example, a resource element may refer to a resource unit of 1 symbol (in reference to a time resource, e.g. a time period of specific length) per 1 subcarrier (in reference to a frequency resource, e.g. a specific frequency bandwidth, which may be centered on a specific frequency). A resource element group (REG) has the full extent of its ordinary meaning and at least refers to a specified number of consecutive resource elements. In some implementations, a resource element group may not include resource elements reserved for reference signals. A control channel element (CCE) refers to a group of a specified number of consecutive REGs. A resource block (RB) refers to a specified number of resource elements made up of a specified number of subcarriers per specified number of symbols. Each RB may include a specified number of subcarriers. A resource block group (RBG) refers to a unit including multiple RBs. The number of RBs within one RBG may differ depending on the system bandwidth.
Bandwidth Part (BWP)—A carrier bandwidth part (BWP) is a contiguous set of physical resource blocks selected from a contiguous subset of the common resource blocks for a given numerology on a given carrier. For downlink, a UE may be configured with up to a specified number of carrier BWPs (e.g. four BWPs, per some specifications), with one BWP per carrier active at a given time (per some specifications). For uplink, the UE may similarly be configured with up to several (e.g. four) carrier BWPs, with one BWP per carrier active at a given time (per some specifications). If a UE is configured with a supplementary uplink, then the UE may be additionally configured with up to the specified number (e.g. four) carrier BWPs in the supplementary uplink, with one carrier BWP active at a given time (per some specifications).
Multi-cell Arrangements—A Master node is defined as a node (radio access node) that provides control plane connection to the core network in case of multi radio dual connectivity (MR-DC). A master node may be a master eNB (3GPP LTE) or a master gNB (3GPP NR), for example. A secondary node is defined as a radio access node with no control plane connection to the core network, providing additional resources to the UE in case of MR-DC. A Master Cell group (MCG) is defined as a group of serving cells associated with the Master Node, including the primary cell (PCell) and optionally one or more secondary cells (SCell). A Secondary Cell group (SCG) is defined as a group of serving cells associated with the Secondary Node, including a special cell, namely a primary cell of the SCG (PSCell), and optionally including one or more SCells. A UE may typically apply radio link monitoring to the PCell. If the UE is configured with an SCG then the UE may also apply radio link monitoring to the PSCell. Radio link monitoring is generally applied to the active BWPs and the UE is not required to monitor inactive BWPs. The PCell is used to initiate initial access, and the UE may communicate with the PCell and the SCell via Carrier Aggregation (CA). Currently Amended capability means a UE may receive and/or transmit to and/or from multiple cells. The UE initially connects to the PCell, and one or more SCells may be configured for the UE once the UE is in a connected state.
Core Network (CN)—Core network is defined as a part of a 3GPP system which is independent of the connection technology (e.g. the Radio Access Technology, RAT) of the UEs. The UEs may connect to the core network via a radio access network, RAN, which may be RAT-specific.
Downlink Control Information (DCI)—In 3GPP communications, DCI is transmitted to a mobile device or UE (e.g., by a serving base station in the network) and contains multiple different fields. Each field is used to configure one part or aspect of a scheduled communication(s) of the device. To put it another way, each field in the DCI may correspond to a specific communication parameter or parameters configuring a corresponding aspect of the scheduled communication(s) of the device. By decoding the DCI, the UE obtains all the configuring parameters or parameter values according to the fields in the DCI, thereby obtaining all the information about the scheduled communication(s) and subsequently performing the scheduled communication(s) according to those parameters/parameter values.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

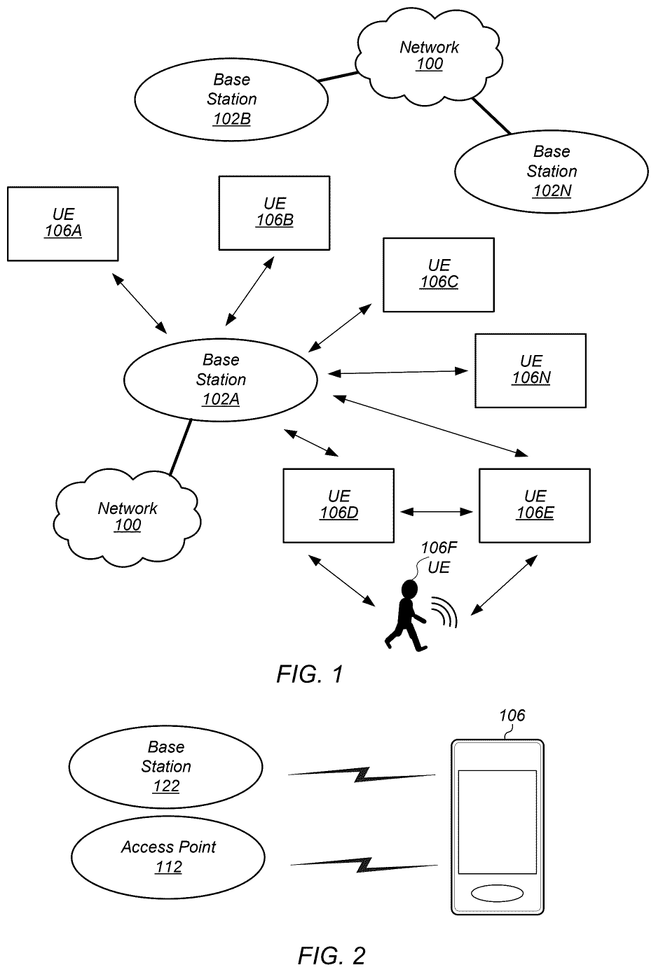

### FIGS. 1 and 2—Exemplary Communication Systems

FIG. 1 illustrates an exemplary (and simplified) wireless communication system, according to some embodiments. It is noted that the system of FIG. 1 is merely one example of a possible system, and embodiments may be implemented in any of various systems, as desired.

As shown, the exemplary wireless communication system includes base stations 102A through 102N, also collectively referred to as base station(s) 102 or base station 102. As shown in FIG. 1, base station 102A communicates over a transmission medium with one or more user devices 106A through 106N. Each of the user devices may be referred to herein as a “user equipment” (UE) or UE device. Thus, the user devices 106A through 106N are referred to as UEs or UE devices, and are also collectively referred to as UE(s) 106 or UE 106.

The base station 102A may be a base transceiver station (BTS) or cell site, and may include hardware that enables wireless communication with the UEs 106A through 106N. The base station 102A may also be equipped to communicate with a network 100 (e.g., a core network of a cellular service provider, a telecommunication network such as a public switched telephone network (PSTN), and/or the Internet, neutral host or various CBRS (Citizens Broadband Radio Service) deployments, among various possibilities). Thus, the base station 102A may facilitate communication between the user devices 106 and/or between the user devices 106 and the network 100. In particular, the cellular base station 102A may provide UEs 106 with various telecommunication capabilities, such as voice, short message service (SMS) and/or data services. The communication area (or coverage area) of the base station 106 may be referred to as a “cell.” It is noted that “cell” may also refer to a logical identity for a given wireless communication coverage area at a given frequency. In general, any independent cellular wireless coverage area may be referred to as a “cell”. In such cases a base station may be situated at particular confluences of three cells. The base station, in this uniform topology, may serve three 120 degree beam width areas referenced as cells. Also, in case of carrier aggregation, small cells, relays, etc. may each represent a cell. Thus, in carrier aggregation in particular, there may be primary cells and secondary cells which may service at least partially overlapping coverage areas but on different respective frequencies. For example, a base station may serve any number of cells, and cells served by a base station may or may not be collocated (e.g. remote radio heads). As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network, and may further also be considered at least a part of the UE communicating on the network or over the network.

The base station(s) 102 and the user devices 106 may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G-NR (NR, for short), 3GPP2 CDMA2000 (e.g., 1×RTT, 1×EV-DO, HRPD, eHRPD), Wi-Fi, WiMAX etc. Note that if the base station 102A is implemented in the context of LTE, it may alternately be referred to as an ‘eNodeB’ or ‘eNB’. Similarly, if the base station 102A is implemented in the context of 5G NR, it may alternately be referred to as ‘gNodeB’ or ‘gNB’. In some embodiments, the base station 102 (e.g. an eNB in an LTE network or a gNB in an NR network) may communicate with at least one UE having the capability to transmit reference signals according to various embodiments disclosed herein. Depending on a given application or specific considerations, for convenience some of the various different RATs may be functionally grouped according to an overall defining characteristic. For example, all cellular RATs may be collectively considered as representative of a first (form/type of) RAT, while Wi-Fi communications may be considered as representative of a second RAT. In other cases, individual cellular RATs may be considered individually as different RATs. For example, when differentiating between cellular communications and Wi-Fi communications, “first RAT” may collectively refer to all cellular RATs under consideration, while “second RAT” may refer to Wi-Fi. Similarly, when applicable, different forms of Wi-Fi communications (e.g. over 2.4 GHz vs. over 5 GHz) may be considered as corresponding to different RATs. Furthermore, cellular communications performed according to a given RAT (e.g. LTE or NR) may be differentiated from each other on the basis of the frequency spectrum in which those communications are conducted. For example, LTE or NR communications may be performed over a primary licensed spectrum as well as over a secondary spectrum such as an unlicensed spectrum and/or spectrum that was assigned to private networks. Overall, the use of various terms and expressions will always be clearly indicated with respect to and within the context of the various applications/embodiments under consideration.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices 106 and/or between the user devices 106 and the network 100. In particular, the cellular base station 102A may provide UEs 106 with various telecommunication capabilities, such as voice, SMS and/or data services. UE 106 may be capable of communicating using multiple wireless communication standards. For example, a UE 106 might be configured to communicate using any or all of a 3GPP cellular communication standard (such as LTE or NR) or a 3GPP2 cellular communication standard (such as a cellular communication standard in the CDMA2000 family of cellular communication standards). Base station 102A and other similar base stations (such as base stations 102B . . . 102N) operating according to the same or a different cellular communication standard may thus be provided as one or more networks of cells, which may provide continuous or nearly continuous overlapping service to UE 106 and similar devices over a wide geographic area via one or more cellular communication standards.

Thus, while base station 102A may act as a “serving cell” for UEs 106A-106N as illustrated in FIG. 1, each one of UE(s) 106 may also be capable of receiving signals from (and may possibly be within communication range of) one or more other cells (possibly provided by base stations 102B-102N and/or any other base stations), which may be referred to as “neighboring cells”. Such cells may also be capable of facilitating communication in-between user devices 106 and/or between user devices 106 and the network 100. Such cells may include “macro” cells, “micro” cells, “pico” cells, and/or cells which provide any of various other granularities of service area size. For example, base stations 102A-102B illustrated in FIG. 1 may be macro cells, while base station 102N may be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transmission and reception points (TRPs). In addition, a UE capable of operating according to 5G NR may be connected to one or more TRPs within one or more gNBs.

The UE 106 might also or alternatively be configured to communicate using WLAN, BLUETOOTH™, BLUETOOTH™ Low-Energy, one or more global navigational satellite systems (GNSS, e.g., GPS or GLONASS), one and/or more mobile television broadcasting standards (e.g., ATSC-M/H or DVB-H), etc. Other combinations of wireless communication standards (including more than two wireless communication standards) are also possible. Furthermore, the UE 106 may also communicate with Network 100, through one or more base stations or through other devices, stations, or any appliances not explicitly shown but considered to be part of Network 100. UE 106 communicating with a network may therefore be interpreted as the UE(s) 106 communicating with one or more network nodes considered to be a part of the network and which may interact with the UE(s) 106 to conduct communications with the UE(s) 106 and in some cases affect at least some of the communication parameters and/or use of communication resources of the UE(s) 106.

As also illustrated in FIG. 1, at least some of the UEs, e.g. UEs 106D and 106E may represent vehicles communicating with each other and with base station 102, e.g. via cellular communications such as 3GPP LTE and/or 5G-NR communications, for example. In addition, UE 106F may represent a pedestrian who is communicating and/or interacting in a similar manner with the vehicles represented by UEs 106D and 106E. Various embodiments of vehicles communicating in a network exemplified in FIG. 1 are disclosed, for example, in the context of vehicle-to-everything (V2X) communications such as the communications specified by certain versions of the 3GPP standard, among others.

FIG. 2 illustrates an exemplary user equipment 106 (e.g., one of UEs 106A through 106N) in communication with the base station 122 and an access point 112, according to some embodiments. The UE 106 may be a device with both cellular communication capability and non-cellular communication capability (e.g., BLUETOOTH™, Wi-Fi, and so forth) such as a mobile phone, a hand-held device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, NR, WLAN, or GNSS. Other combinations of wireless communication standards are also possible.

The UE 106 may include one or more antennas for communicating using one or more wireless communication protocols according to one or more RAT standards, e.g. those previously mentioned above. In some embodiments, the UE 106 may share one or more parts of a receive chain and/or transmit chain between multiple wireless communication standards. The shared radio may include a single antenna, or may include multiple antennas (e.g., for MIMO) for performing wireless communications. Alternatively, the UE 106 may include separate transmit and/or receive chains (e.g., including separate antennas and other radio components) for each wireless communication protocol with which it is configured to communicate. As another alternative, the UE 106 may include one or more radios or radio circuitry which are shared between multiple wireless communication protocols, and one or more radios which are used exclusively by a single wireless communication protocol. For example, the UE 106 may include radio circuitries for communicating using either of LTE or CDMA2000 1×RTT or NR, and separate radios for communicating using each of Wi-Fi and BLUETOOTH™. Other configurations are also possible.

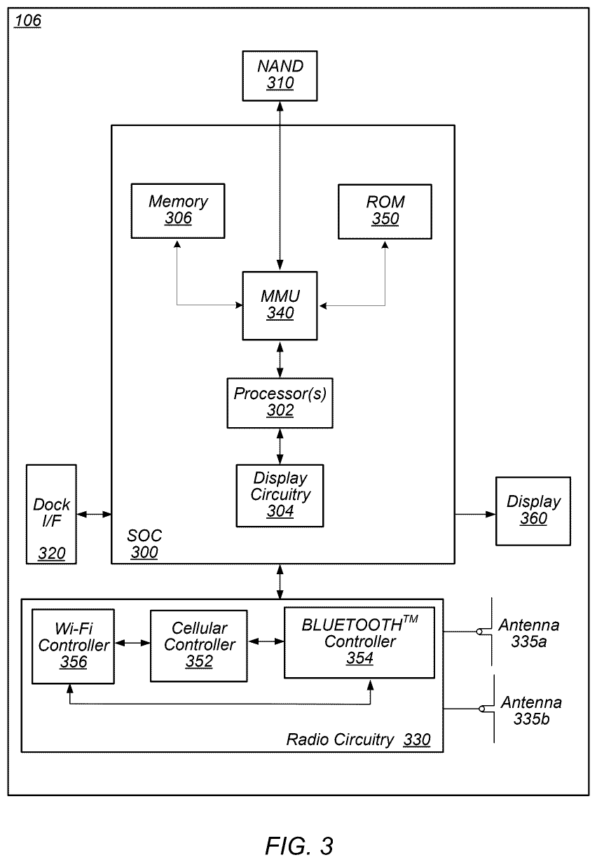

### FIG. 3—Block Diagram of an Exemplary UE

FIG. 3 illustrates a block diagram of an exemplary UE 106, according to some embodiments. As shown, the UE 106 may include a system on chip (SOC) 300, which may include various elements/components for various purposes. For example, as shown, the SOC 300 may include processor(s) 302 which may execute program instructions for the UE 106 and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio circuitry 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to the computer system), the display 360, and wireless communication circuitry (e.g., for LTE, LTE-A, NR, CDMA2000, BLUETOOTH™, Wi-Fi, GPS, etc.). The UE device 106 may include at least one antenna (e.g. 335a), and possibly multiple antennas (e.g. illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna(s) 335. For example, the UE device 106 may use antenna(s) 335 to perform the wireless communication with the aid of radio circuitry 330. As noted above, the UE may be configured to communicate wirelessly using multiple wireless communication standards in some embodiments.

As further described herein, the UE 106 (and/or base station 102) may include hardware and software components for implementing methods for at least UE 106 to transmit reference signals according to various embodiments disclosed herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to implement communications by UE 106 to transmit reference signals according to various embodiments disclosed herein. Specifically, processor(s) 302 may be coupled to and/or may interoperate with other components as shown in FIG. 3 to facilitate UE 106 communicating in a manner that seeks to optimize RAT selection. Processor(s) 302 may also implement various other applications and/or end-user applications running on UE 106.

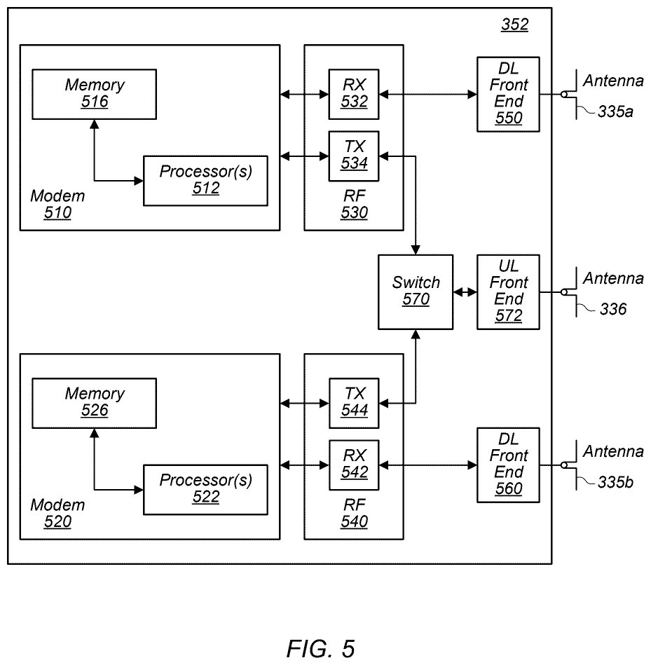

In some embodiments, radio circuitry 330 may include separate controllers dedicated to controlling communications for various respective RATs and/or RAT standards. For example, as shown in FIG. 3, radio circuitry 330 may include a Wi-Fi controller 356, a cellular controller (e.g. LTE and/or NR controller) 352, and BLUETOOTH™ controller 354, and according to at least some embodiments, one or more or all of these controllers may be implemented as respective integrated circuits (ICs or chips, for short) in communication with each other and with SOC 300 (e.g. with processor(s) 302). For example, Wi-Fi controller 356 may communicate with cellular controller 352 over a cell-ISM link or WCI interface, and/or BLUETOOTH™ controller 354 may communicate with cellular controller 352 over a cell-ISM link, etc. While three separate controllers are illustrated within radio circuitry 330, other embodiments may have fewer or more similar controllers for various different RATs and/or RAT standards that may be implemented in UE device 106. For example, at least one exemplary block diagram illustrative of some embodiments of cellular controller 352 is shown in FIG. 5 and will be further described below.

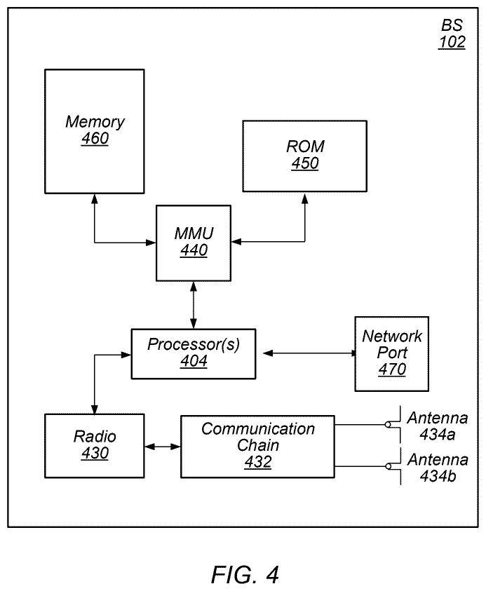

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434a, and possibly multiple antennas (e.g. illustrated by antennas 434a and 434b), for performing wireless communication with mobile devices and/or other devices. Antennas 434a and 434b are shown by way of example, and base station 102 may include fewer or more antennas. Overall, the one or more antennas, which may include antenna 434a and/or antenna 434b, are collectively referred to as antenna 434 or antenna(s) 434. Antenna(s) 434 may be configured to operate as a wireless transceiver and may be further configured to communicate with UE devices 106 via radio circuitry 430. The antenna(s) 434 communicates with the radio 430 via communication chain 432. Communication chain 432 may be a receive chain, a transmit chain or both. The radio circuitry 430 may be designed to communicate via various wireless telecommunication standards, including, but not limited to, LTE, LTE-A, 5G-NR (NR) WCDMA, CDMA2000, etc. The processor(s) 404 of the base station 102 may be configured to implement part or all of the methods described herein, e.g., by executing program instructions stored on a memory medium (e.g., a non-transitory computer-readable memory medium). Alternatively, the processor(s) 404 may be configured as a programmable hardware element(s), such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g. it may include at least one Ethernet port, and radio 430 may be designed to communicate according to the Wi-Fi standard.

### FIG. 5—Exemplary Cellular Communication Circuitry

FIG. 5 illustrates an exemplary simplified block diagram illustrative of cellular controller 352, according to some embodiments. It is noted that the block diagram of the cellular communication circuitry of FIG. 5 is only one example of a possible cellular communication circuit; other circuits, such as circuits including or coupled to sufficient antennas for different RATs to perform uplink activities using separate antennas, or circuits including or coupled to fewer antennas, e.g., that may be shared among multiple RATs, are also possible. According to some embodiments, cellular communication circuitry 352 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 352 may couple (e.g., communicatively; directly or indirectly) to one or more antennas, such as antennas 335a-b and 336 as shown. In some embodiments, cellular communication circuitry 352 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 5, cellular communication circuitry 352 may include a first modem 510 and a second modem 520. The first modem 510 may be configured for communications according to a first RAT, e.g., such as LTE or LTE-A, and the second modem 520 may be configured for communications according to a second RAT, e.g., such as 5G NR.

As shown, the first modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, the second modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 352 receives instructions to transmit according to the first RAT (e.g., as supported via the first modem 510), switch 570 may be switched to a first state that allows the first modem 510 to transmit signals according to the first RAT (e.g., via a transmit chain that includes transmit circuitry 534 and UL front end 572). Similarly, when cellular communication circuitry 352 receives instructions to transmit according to the second RAT (e.g., as supported via the second modem 520), switch 570 may be switched to a second state that allows the second modem 520 to transmit signals according to the second RAT (e.g., via a transmit chain that includes transmit circuitry 544 and UL front end 572).

As described herein, the first modem 510 and/or the second modem 520 may include hardware and software components for implementing any of the various features and techniques described herein. The processors 512, 522 may be configured to implement part or all of the features described herein, e.g., by executing program instructions stored on a memory medium (e.g., a non-transitory computer-readable memory medium). Alternatively (or in addition), processors 512, 522 may be configured as a programmable hardware element, such as an FPGA (Field Programmable Gate Array), or as an ASIC (Application Specific Integrated Circuit). Alternatively (or in addition) the processors 512, 522, in conjunction with one or more of the other components 530, 532, 534, 540, 542, 544, 550, 570, 572, 335 and 336 may be configured to implement part or all of the features described herein.

In addition, as described herein, processors 512, 522 may include one or more components. Thus, processors 512, 522 may include one or more integrated circuits (ICs) that are configured to perform the functions of processors 512, 522. In addition, each integrated circuit may include circuitry (e.g., first circuitry, second circuitry, etc.) configured to perform the functions of processors 512, 522.

In some embodiments, the cellular communication circuitry 352 may include only one transmit/receive chain. For example, the cellular communication circuitry 352 may not include the modem 520, the RF front end 540, the DL front end 560, and/or the antenna 335b. As another example, the cellular communication circuitry 352 may not include the modem 510, the RF front end 530, the DL front end 550, and/or the antenna 335a. In some embodiments, the cellular communication circuitry 352 may also not include the switch 570, and the RF front end 530 or the RF front end 540 may be in communication, e.g., directly, with the UL front end 572.

### Measurement and Reporting During Wireless Communications

As previously mentioned, wireless communications, such as NR cellular wireless communications, involve measurement and reporting of various channel and communication metrics. Furthermore, there has been an emergence of mobile services that require low-latency and high-reliability performance (e.g., ultra-reliable low-latency communication, URLLC). The 3GPP NR/5G standard has been designed to address these services. However, the evolution of 5G New Radio (NR) requires continued enhancement of mobility performance robustness for a variety of challenging scenarios.

The currently supported layer 3 (L3) handover/mobility can lead to latency issues, e.g., during handover operations. As part of recent developments, certain objectives have been identified for NR mobility enhancements. One such objective pertains to layer 1 (physical layer; L1) enhancements for inter-cell beam management, including L1 measurement and reporting, and beam indication. The following issues have been identified as relating to these enhancements.

Issue 1: For layer 1/layer 2 (L1/L2)-triggered mobility (LTM), compared to a layer 3 (L3) handover (HO) or mobility, one issue is the potential ping-pong effect caused by L1-RSRP (Reference Signal Received Power) measurement results. Under some circumstances, a device being handed over from a serving cell to a target cell might attempt to return to the serving cell (or serving base station) due to measurements indicating more suitable conditions associated with the serving cell (or serving base station) possibly during a handover operation to the target cell (or target base station). Such a scenario may preempt the device from establishing reliable connectivity on a given cell, attempting to move from one cell to another and back. This may occur, for example, with reduced latency LTM operations. Solving or mitigating this issue would lead to increased L1-based HO reliability. For L1/L2-based inter-cell mobility, it might be necessary to configure a very large number of target candidate cells and beams to perform L1 measurement(s), and subsequently trigger HO operations in a timely manner to reduce latency. If the network (e.g., a serving base station of the network) requests the UE to transmit a report that includes a physical cell identifier (PCI), and/or any Synchronization Signal/PBCH Block (SSB) index, each entry in the report could consume more than 20 bits. If the network additionally requested the inclusion of more than a specified number of, e.g., four, measurements in a single report, the report may significantly increase in size, relative to current legacy reports.

Issue 2: Another issue is the potential size of the L1 report overhead, and reduction of this overheard.

Issue 3: Presently, Inter-Cell Beam Management (ICBM) L1 measurement(s) for a non-serving cell(s) is limited to intra-frequency measurement(s) and within the UE's active BWP, and therefore no measurement gap(s) is (are) needed. However, in the future, inter-frequency handovers may also include L1/L2-based handovers. Consequently, the issue still remains of how to design/perform measurement(s) for the inter-frequency case for L1/L2 based handovers.

### L1 Measurement Enhancement for Inter-Cell Mobility

In accordance with various embodiments disclosed herein, different metrics may be explicitly configured by the network for L1 measurement reporting with the higher layer parameter reportQuantity in CSI-ReportConfig set to L1-RSRP or L1-RSRQ (Reference Signal Received Quality) or L1-SINR (Signal-To-Interference-Plus-Noise Ratio). As further described herein, more detailed description is provided in reference to the use of L1-RSRP, but the description equally applies to other L1 measurement metrics, e.g., L1-RSRQ, L1-SINR, etc. In some embodiments, a variety of approaches may be considered to enhance the L1 measurements for L1/L2-based inter-cell mobility such that the ping-pong effect is mitigated.

### First Approach: L1 Cell-Level Metric

According to some embodiments, a cell-level L1 measurement metric, e.g., L1-RSRP, result may be derived/determined for a specified frequency layer, e.g., “frequency range 2” (FR2) frequency layer by averaging measured L1-RSRPs corresponding to a specified number, K, of best SSB beams. In some embodiments the value of K may be set as K≤4. As also previously mentioned, it should be noted that while various exemplary descriptions herein reference specific L1 measurement metrics (e.g., L1-RSRP), specified number of beams (e.g., 4), and/or parameters (e.g., SSB), the methods and systems detailed herein are not limited to those specific values/examples.

In some embodiments, the derived/determined cell-level L1-RSRP quantity may be included in an L1 measurement report to network. Alternatively, the derived cell-level measurement metric may be used as a criterion to determine whether or not to trigger an event-based L1 reporting, as will further detailed below.

In some embodiments, the maximum number of beams to be averaged (denoted by the parameter ‘nrofSS-BlocksToAverage’) and beam consolidation thresholds (denoted by the parameter ‘absThreshSS-BlocksConsolidation’) may be configured in the L1 measurement configuration for the derivation of cell-level L1-RSRP results. Accordingly, L1-RSRP results above ‘absThreshSS-BlocksConsolidation’ may be considered (or may qualify) for the averaging operation, and the total number of L1-RSRP results may not be above “nrofSS-BlocksToAverage”. In case no ‘nrofSS-BlocksToAverage’ or “absThreshSS-BlocksConsolidation’ is configured, the UE may report cell-specific L1-RSRP results according to different criteria, for example, based on the SS/PBCH (search space/physical broadcast channel) block having the highest beam measurement quantity value.

Two options may be considered for the averaging operation. According to a first option, derivation of the cell-level L1-RSRP may include the linear averaging of the L1-RSRP values corresponding to (or associated with) the best ‘K’ beams. According to a second option, the coefficient values for the averaging may be configured via RRC signaling.

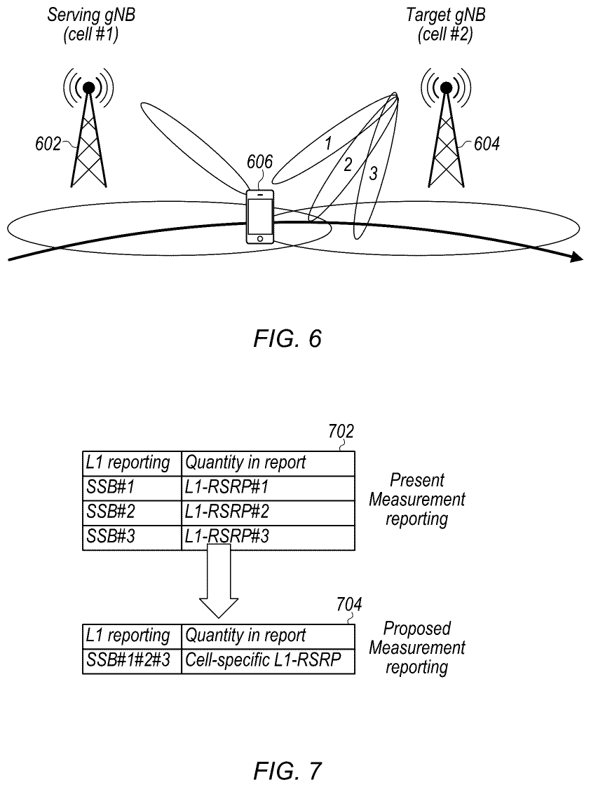

FIG. 6 shows an exemplary diagram illustrating one example of cell-specific L1 measurement. The measurements may be performed by UE 606, which may be moving from a coverage area of cell #1 served by base station 602 into coverage area of cell #2 served by base station 604, which therefore represents the target base station for a L1/L2 handover operation. As shown in FIG. 6, according to the first approach, three beam-specific L1-RSRPs may be measured for corresponding beams #1/#2/#3 of cell #2, respectively. The measured L1-RSRP values may then be averaged first, and then this averaged cell-specific quantity may be included in the L1 measurement report or metric and may be also be used to determine whether to trigger L1 reporting to the serving base station 602.

FIG. 7 shows an exemplary table comparison indicating the number of reported values included in L1 measurement reports for a given L1 measurement metric. Table 702 corresponds to the measurement reporting as performed today, while table 704 corresponds to proposed measurement reporting with a reduced number of reported values. As shown in FIG. 7, the L1 reporting overhead may be significantly reduced, especially when the number of reported candidate cells significantly increases. For example, instead of reporting multiple values for each candidate cell (as illustrated in table 702), only a single value may need to be reported for each cell (as illustrated in table 704). Therefore, the reporting overhead may be reduced and the L1 handover reliability may be improved.

### Second Approach: Optional Selection of Cell-Specific or Beam-Specific Reporting

In some embodiments, a UE may have the option to derive cell-specific or beam-specific measurement results for candidate cells. For example, setting the nrofSS-BlocksToAverage parameter to ‘1’ (thereby setting the maximum number of beams to be averaged to be 1), may be interpreted as an indication of beam-specific L1-RSRP reporting. Setting the nrofSS-BlocksToAverage parameter to a value greater than 1 may in turn be interpreted as an indication of cell-specific RSRP reporting (and the first approach may be applied.)

### Event-Triggered L1 Measurement Reporting

In some embodiments, event-triggered L1 measurement reporting may also be implemented for L1/L2-based inter-cell mobility. For example, L1 measurement reporting may be triggered based on a candidate cell deemed (or having been determined) to be preferable to a current cell, based a configurable offset value. The measurement metric used to determine whether the condition is met (e.g., whether the value of a measurement metric for the candidate cell reflects a difference greater than the offset value relative to the measurement metric corresponding to the current cell) may be configured to be either cell-level or beam-level, as described above with regard to the second approach pertaining to the proposed L1 measurement enhancements.

Pursuant to the above, a variety of signaling may be considered to convey the event-triggered L1-RSRP measurement results (or more generally, L1 measurement metric measurement results).

### First Approach: MAC-CE-Based Reporting

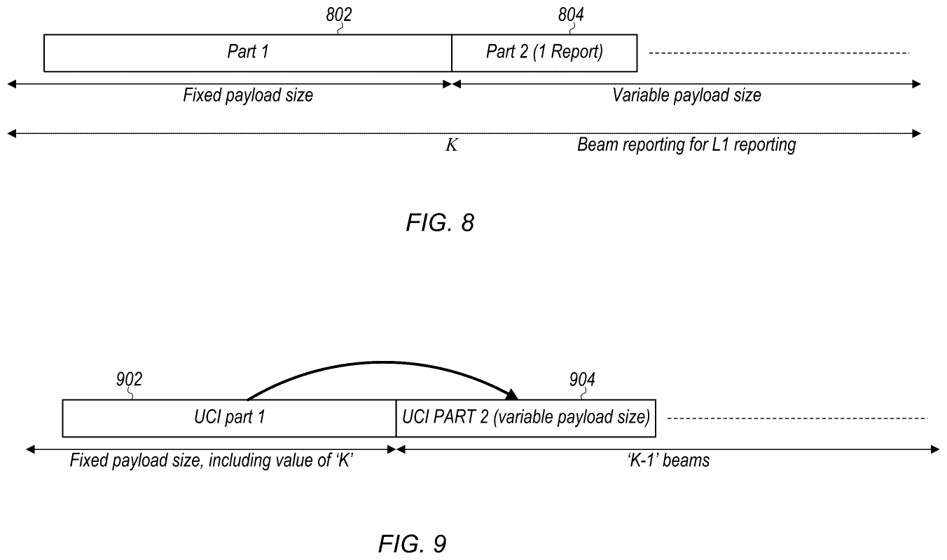

In some embodiments, a new MAC-CE may be introduced to report the measured L1-RSRP, or more generally to report the measured L1 measurement metric. The MAC-CE may be identified by a MAC subheader with dedicated logical channel ID (LCID). The MAC-CE size may be variable and may include the following information fields, referenced in FIG. 8:
Part 1 (802; FIG. 8) is the first information field and contains: the best beam index identifying the beam with the largest measured L1-RSRP value, the measured L1-RSRP value for the best beam, and an associated cell index for the best beam; and
Part 2 (804; FIG. 8) is the second information field and contains: (as an addition to Part 1), beam indices identifying a specified number, ‘K−1’, reported beams, the L1-RSRP measurement results (or more generally, the physical layer metric measurement results) for each reported beam, and the associated cell indices for the reported beams, where 1≤K≤Kₘₐₓ.

The maximum number Kₘₐₓ may be configured by RRC signaling e.g., Kₘₐₓ=3 and may be subject to the capability of the UE (or UE capability). The value of ‘K’ (which refers to the number of reported beams in a report) may be variable depending on the measurement results. L1-RSRP measurement results having values above the beam consolidation threshold (‘absThreshSS-BlocksConsolidation’) may be considered (or may be deemed to qualify) for inclusion in a report. In some embodiments, the ‘K−1’ reported beams may use a differential L1-RSRP based reporting relative to a reference measurement representative of the largest measured L1-RSRP value that is part of the same L1-RSRP reporting instance (in reference to Part 1 above.) Compared to Part-1, each of the ‘K−1’ reported beams may be quantized to a smaller number of bits by using a larger step size.

### Second Approach: L1 Measurement Reported as UCI Via PUCCH or PUSCH Resource

The measurement report may be transmitted as uplink control information UCI) via either a PUCCH or PUSCH resource. The PUCCH resource or PUSCH resource may be correspondingly configured by RRC as part of the L1 (e.g., PL CSI) measurement configuration. An exemplary illustration of this approach is provided in FIG. 9. The fields proposed for the first approach above may be reused in this second approach. They are indicated as Part 1 (902; FIG. 9) and Part 2 (904; FIG. 9). The Part 1 (902) and Part 2 (904) information fields, respectively, for the UCI may be similar to the information fields 802 and 804, respectively, described above for the MAC-CE. The size of the (UCI) (affected by the number ‘K’ of reported beams) may also be variable as indicated above in the description of the first approach. To minimize the decoding complexity of a variable-size of UCI, the value of ‘K’ may be encoded using a separate field and modulation order (e.g., quadrature phase shift keying, QPSK). The resource element (RE) numbers corresponding to the number (of reported beams) may be derived based on a RRC-configured parameter value.

### Measurement Gap for L1 Measurement Operation

In some embodiments, for L1/L2-based handovers, inter-frequency handovers may be supported even where the measured reference signal (RS) of a target cell is on a different frequency relative to the serving cell. Accordingly, a measurement gap may be configured as part of the L1 measurement configuration. In some embodiments, a parameter “measGapConfig” may be used to setup and release measurement gaps in NR for L1 measurement. The parameter may be included in an information element (IE) as further detailed below.

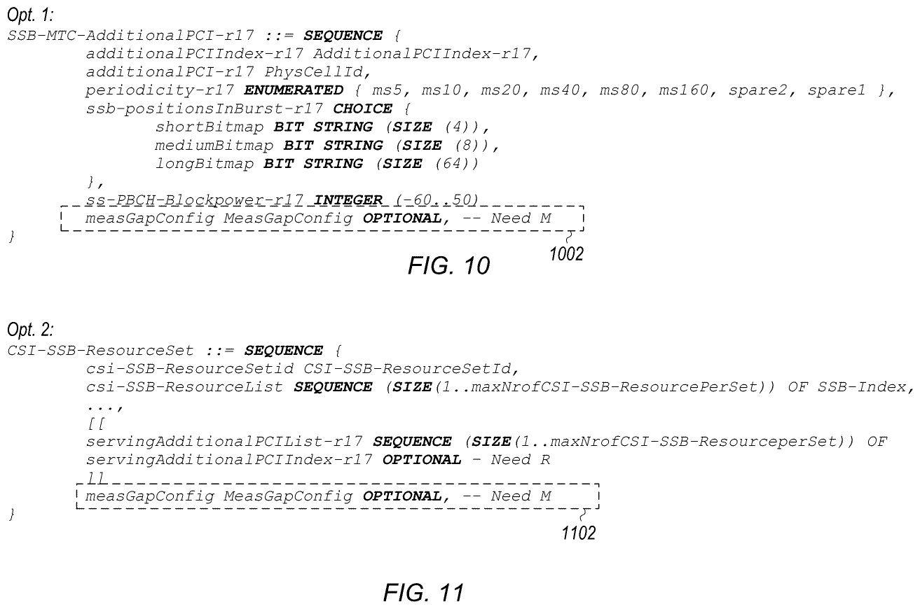

According to a first option, measurement gap indication may be provided on a per ‘non-serving cell’ basis, e.g., by adding a ‘measGapConfig’ parameter into the ‘SSB-MTC-AdditionalPCI’ message, as indicated by item 1002 in FIG. 10. This option provides flexibility that allows configuring a different measurement gap for each non-serving cell on a same frequency layer, when different subcarrier spacings (SCSs) are used relative to the serving cell.

According to a second option, measurement gap indication may be provided on a per-frequency-layer basis, as indicated by item 1102 in FIG. 11. The assumption here is that the same SCS pattern and the same SSB pattern may be used for all candidate cells on a same frequency-layer. Hence, it may be sufficient to configure a single measurement gap and apply this measurement gap for all non-serving cells on a frequency-layer to minimize signaling overhead.

### Exemplary Method for Physical Layer Measurement Reporting

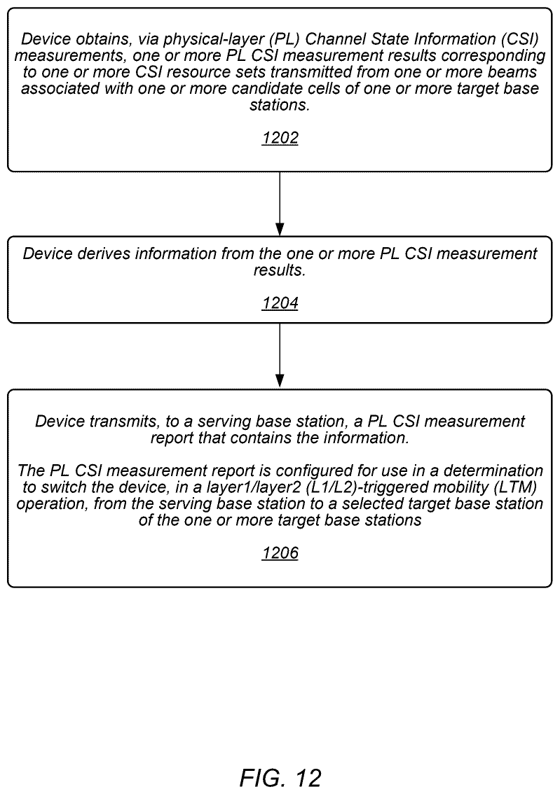

FIG. 12 shows an exemplary flow diagram illustrating obtaining and transmitting a physical layer measurement report, according to some embodiments. A device, for example a mobile device (UE) may obtain, via physical-layer (PL) Channel State Information (CSI) measurements, one or more PL CSI measurement results corresponding to one or more CSI resource sets transmitted from one or more beams associated with one or more candidate cells of one or more target base stations (1202). The device may then derive information from the one or more PL CSI measurement results (1204) and may transmit, to a serving base station, a PL CSI measurement report that contains the information (1206). The PL CSI measurement report may be configured for use in a determination to switch the device, in a layer1/layer2 (L1/L2)-triggered mobility (LTM) operation, from the serving base station to a selected target base station of the one or more target base stations. The information may include cell-level or beam-level metrics, transmission of the PL CSI measurement report may be event triggered and may take place as UCI over a PUCCH or PUSCH resource or in MAC-CE, and a measurement gap may be configured for the PL CSI measurements, as disclosed herein and previously described in further detail.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method for wireless communications, the method comprising:
obtaining, by a device via physical-layer (PL) Channel State Information (CSI) measurements, one or more PL CSI measurement results corresponding to one or more CSI resource sets transmitted from one or more beams associated with one or more candidate cells of one or more target base stations; and
transmitting, by the device, to a serving base station, a PL CSI measurement report that contains information derived from the one or more PL CSI measurement results, wherein the PL CSI measurement report is configured for use in a determination to switch the device, in a layer1/layer2 (L1/L2)-triggered mobility (LTM) operation, from the serving base station to a selected target base station of the one or more target base stations.

2. The method of claim 1, further comprising performing, by the device, one of:
obtaining an averaged PL CSI measurement result by averaging a single plurality of PL CSI measurement results of the one or more PL CSI measurement results, wherein the single plurality of PL CSI measurement results corresponds to a single plurality of beams of the one or more beams and is associated with a single target base station of the one or more target base stations; or
obtaining a plurality of averaged PL CSI measurement results by averaging multiple pluralities of PL CSI measurement results of the one or more PL CSI measurement results, wherein each different plurality of PL CSI measurement results of the multiple pluralities of PL CSI measurement results corresponds to a respective plurality of beams of the one or more beams and is associated with a different respective target base station of the one or more target base stations;
wherein the information includes one of:
the averaged PL CSI measurement result; or
the plurality of averaged PL CSI measurement results.

3. The method of claim 2, wherein the single plurality of beams comprises a specified number of best beams, wherein each best beam of the specified number of best beams is associated with a synchronization signal/physical broadcast channel block (SSB).

4. The method of claim 2, wherein each of the respective plurality of beams comprises a number of respective best beams, wherein each best beam of the number of respective best beams is associated with a synchronization signal/physical broadcast channel block (SSB).

5. The method of claim 2, wherein the averaging of the single plurality of PL CSI measurement results comprises one of:
linearly averaging the single plurality of PL CSI measurement results; or
averaging the single plurality of PL CSI measurement results using coefficient values configured via radio resource control (RRC) signaling; and
wherein the averaging of the multiple pluralities of PL CSI measurement results comprises one of:
linearly averaging the multiple pluralities of PL CSI measurement results; or
averaging the multiple pluralities of PL CSI measurement results using the coefficient values configured via RRC signaling.

6. The method of claim 2, wherein the single plurality of PL CSI measurement results comprises only PL CSI measurement results having a greater value than a specified threshold value;
wherein each of the multiple pluralities of PL CSI measurement results comprises only PL CSI measurement results having a greater value than the specified threshold value; and
wherein at least one of the specified threshold value, a number of the plurality of beams, or a number of each respective plurality of beams is configured in a PL CSI measurement configuration.

7. (canceled)

8. The method of claim 1, wherein the information is derived from PL CSI measurement results of the one or more PL CSI measurement results that each correspond to a single respective beam of the one or more beams, and
wherein a decision to derive the information from the PL CSI measurement results of the one or more PL CSI measurement results that each correspond to a single respective beam of the one or more beams is based on a value of a parameter configured in a PL CSI measurement configuration.

9. (canceled)

10. The method of claim 1, wherein transmitting the PL CSI measurement report is based on a trigger event, wherein the trigger event is determined based on a comparison of first information and second information, wherein the first information is derived from first one or more PL CSI measurement results corresponding to the serving base station, and wherein the second information is derived from second one or more PL CSI measurement results corresponding to a candidate target base station of the one or more target base stations.

11. The method of claim 10, wherein the trigger event is triggered when the comparison indicates that a result indicated by the second information is better than a result indicated by the first information by at least a configurable offset value.

12. The method of claim 1, wherein the PL CSI measurement report is transmitted in a media access control element (MAC-CE) of variable size, wherein the MAC-CE comprises:
a first information field comprising
a best beam index identifying a best beam,
a specified PL CSI measurement result for the best beam, and
an associated cell index for the best beam; and
a second information field comprising
beam indices identifying a specified number of reported beams,
PL CSI measurement results for each reported beam of the specified number of reported beams, and
associated cell indices for the specified number of reported beams.

13. The method of claim 12, wherein the specified PL CSI measurement result represents a largest value among multiple PL CSI measurement results.

14. The method of claim 12, wherein for multiple reported beams, a differential PL CSI reporting is used with reference to the specified PL CSI measurement result.

15. The method of claim 14, wherein each PL CSI reporting for the number of reported beams is quantized to a smaller number of bits by using a larger step size.

16. The method of claim 1, wherein the PL CSI measurement report is transmitted as uplink control information (UCI) using either one of a physical uplink control channel (PUCCH) resource or a physical uplink shared channel (PUSCH) resource.

17. The method of claim 16, wherein either one or both of the PUCCH resource or the PUSCH resource is configured via radio resource control information as part of a PL CSI measurement configuration.

18. The method of claim 16, wherein the UCI comprises:
a first information field comprising
a best beam index identifying a best beam,
a specified PL CSI measurement result for the best beam, and
an associated cell index for the best beam; and
a second information field comprising
beam indices identifying a specified number of reported beams,
PL CSI measurement results for each reported beam of the specified number of reported beams, and
associated cell indices for the specified number of reported beams.

19. The method of claim 18, wherein the specified number is variable and indicated by the first information field, and
wherein a number of resource elements corresponding to the specified number is derived based on a parameter value configured via radio resource control.

20. (canceled)

21. The method of claim 1, wherein a measurement gap for the PL CSI measurements is configured as part of a PL CSI measurement configuration, and wherein the measurement gap is indicated per one of:
a non-serving cell of a target base station; or
a frequency layer.

22. An apparatus configured to cause a user equipment (UE) to:
obtain, via physical-layer (PL) Channel State Information (CSI) measurements, one or more PL CSI measurement results corresponding to one or more CSI resource sets transmitted from one or more beams associated with one or more candidate cells of one or more target base stations; and
transmit, to a serving base station, a PL CSI measurement report that contains information derived from the one or more PL CSI measurement results, wherein the PL CSI measurement report is configured for use in a determination to switch the UE, in a layer1/layer2 (L1/L2)-triggered mobility (LTM) operation, from the serving base station to a selected target base station of the one or more target base stations.

23. A user equipment (UE) comprising:
radio circuitry configured to enable wireless communications of the UE; and
a processor configured to execute program instructions to cause the UE to:
obtain, via physical-layer (PL) Channel State Information (CSI) measurements, one or more PL CSI measurement results corresponding to one or more CSI resource sets transmitted from one or more beams associated with one or more candidate cells of one or more target base stations; and
transmit, to a serving base station, a PL CSI measurement report that contains information derived from the one or more PL CSI measurement results, wherein the PL CSI measurement report is configured for use in a determination to switch the UE, in a layer1/layer2 (L1/L2)-triggered mobility (LTM) operation, from the serving base station to a selected target base station of the one or more target base stations.

24. (canceled)
